(19) United States
(12) Patent Application Publication
(10) Pub. No.: US 2015/0153568 A1
(43) Pub. Date: Jun. 4, 2015

(54) VIEWING GYRO WINDOW

(71) Applicant: DERSTRONG ENTERPRISE CO., LTD., TAICHUNG CITY (TW)

(72) Inventor: CHENG TSONG LIN, TAICHUNG CITY (TW)

(21) Appl. No.: 14/618,050

(22) Filed: Feb. 10, 2015

Related U.S. Application Data
(63) Continuation of application No. 13/345,708, filed on Jan. 7, 2012.

(51) Int. Cl. G02B 27/00; E06B 7/28

(52) U.S. Cl. CPC G02B 27/0006; E06B 7/28

(57) ABSTRACT

A viewing gyro window includes a fixed ring, a shaft assembly, and a rotating member. The fixed ring is secured with a transparent plate and installed on the transparent panel. The fixed ring has an annular groove and a gas inlet. The shaft assembly is assembled to the center of the transparent plate and is pivoted to a rotating shaft via a bearing. The rotating member has a ring fastened to the periphery of a rotating plate. A linkage member is fastened to the center of the rotating plate and secured with the rotating shaft. T he rotating member is in no contact with the fixed ring. The ring has plates arranged annularly and extending toward the annular groove. High pressure gas enters into the annular groove to drive the plates to rotate the rotating member.

### REFERENCES TO RELATED APPLICATION

This Application is being filed as a Continuation of patent application Ser. No. 13/345,708, filed 7 Jan. 2012, currently pending.

### BACKGROUND OF THE INVENTION

1. Field of the Invention

The present invention relates to a viewing gyro window, and more particularly to a tool installed to a transparent panel and provided as a viewing window.

2. Description of the Prior Art

As shown in FIG. 6, a conventional viewing gyro window is installed to a transparent panel 91 of a machine tool and provided as an observing door for a user. The conventional viewing gyro window is installed to the transparent panel 91 via a fixed ring 92. A bottom end of a center bracket 93 is secured with the fixed ring 92, and a top end of the center bracket 93 is secured with a fixed part 94. A flow regulator 95 is installed in the fixed part 94 and the bottom of the center bracket 93 to enable high pressure gas entering into the fixed part 94 via the center bracket 93 so as to rotate a rotating plate 96 positioned at one side of the fixed ring 92. When cut liquid for machining are spread on the transparent panel 91, the centrifugal force induced from the rotation of the rotating pate 96 would swing the cut liquid for machining off the transparent pane 91, so that clear visions can be provided from parts of the transparent panel 91 where the rotating plate 96 is located at.

However, the conventional viewing gyro window has some drawbacks, described as following.

Firstly, the center bracket 93 is provided to position the fixed part 94 in the fixed ring 92 and acted as a supporting structure for the rotation of the rotating plate 96. Nevertheless, since the center bracket 93 is positioned in the fixed ring 92, user's vision would be blocked and hard to observe the machining condition of an article.

Secondly, the rotating plate 96 is made of glass so as to perform acid and alkali resistant characters. Nevertheless, if the rotating plate 96 is impacted by the article unintentionally during machining, the article would break the rotating plate 96 and further damage the transparent panel 91.

Thirdly, when the rotating plate 96 has to be disassembled from the conventional viewing gyro window, in case of maintenance or repairing, the repairman or the maintenance personnel has to detach the fixed ring 92 from the transparent panel 91 in advance, and then the detachment of the rotating plate 96 can be carried out. Therefore, the structure of the conventional viewing gyro window is inconvenient for maintenance and repairing.

The present invention is, therefore, arisen to obviate or at least mitigate the above mentioned disadvantages.

### SUMMARY OF THE INVENTION

One object of the present invention is to address the aforementioned problems and to provide a viewing gyro window to improve the sight block issue so as to allow an operator to observe a machining condition of an article. Besides, the transparent plate is assembled between the rotating plate and the transparent panel, therefore the transparent plate is acted as a protecting layer when the rotating plate is impacted and broken.

Another object of the present invention is the combination of the rotating member and the rotating shaft is carried out by enabling the locking member passing through the linkage member and locked with the rotating member. Therefore, when the locking member is detached off linkage member, the linkage member is then able to be detached from the rotating shaft, and the rotating member can be detached from the viewing gyro window. The detachment of the rotating member is comparatively easy, facilitating the convenience of maintaining or repairing the rotating member.

To achieve the above and other objects, a viewing gyro window is provided. The viewing gyro window is installed on a transparent panel. The viewing gyro window comprises a fixed ring, a shaft assembly, and a rotating member. The fixed ring has a first side and a second side opposite to the first side. The first side of the fixed ring is secured with a transparent plate, and the first side of the fixed ring is installed on the transparent panel. The second side of the fixed ring has an annular groove defined around the periphery thereof. The fixed ring has a gas inlet for inputting high pressure gas. The gas inlet is defined through the outer periphery of the fixed ring and communicates with the annular groove. The shaft assembly is assembled to the center of the transparent plate. The shaft assembly has a bearing and a rotating shaft, the bearing is received in the shaft assembly, and the rotating shaft is received in the shaft assembly and pivoted with the bearing and rotatable relative to the shaft assembly. The rotating member has a rotating plate made of glass, and a ring is fastened to the periphery of the rotating plate. A linkage member is fastened to the center of the rotating plate. The linkage member is secured with the rotating shaft and located at the second side of the fixed ring, and the rotating member is in no contact with the fixed ring. The ring has a plurality of plates arranged annularly and extending toward the annular groove. The high pressure gas enters into the annular groove to drive the plates to rotate the rotating member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a viewing gyro window according to the present invention;

FIG. 2 is an exploded view of the viewing gyro window according to the present invention;

FIG. 3 is a cross-sectional view of the viewing gyro window according to the present invention;

FIG. 4 is a schematic view showing high pressure gas is entering into an annular groove through a gas inlet;

FIG. 5 is a schematic view showing plates of a ring of the viewing gyro window are pushed by high pressure gas; and

FIG. 6 is a perspective view of a conventional viewing gyro window.

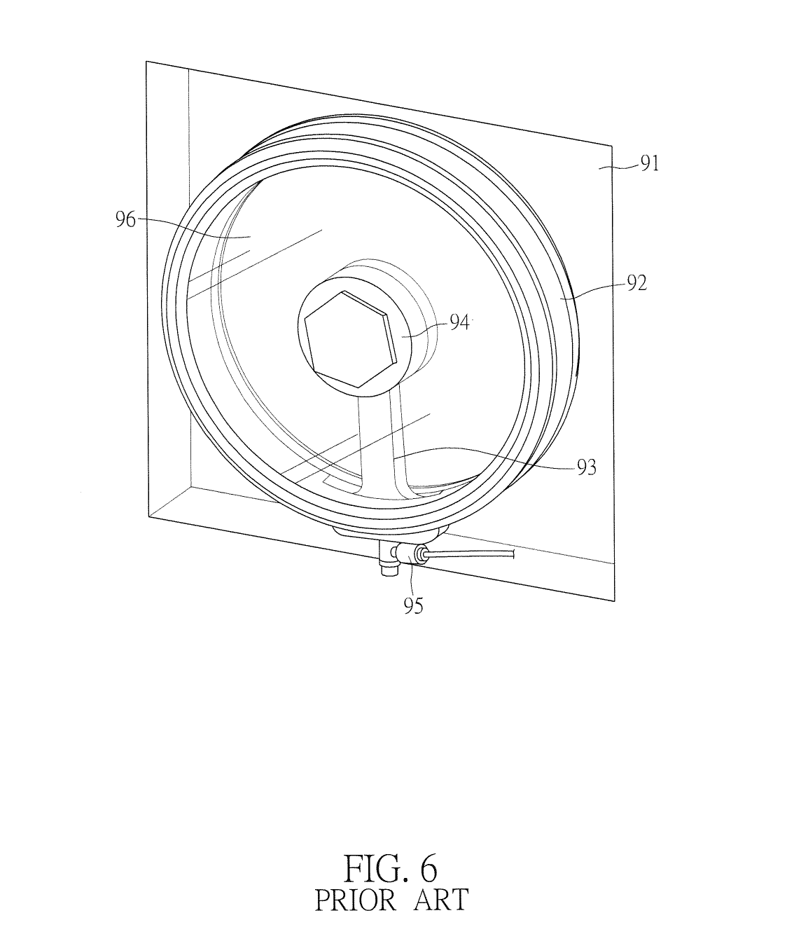

### DETAILED DESCRIPTION OF THE PREFERRED EMBODIMENTS

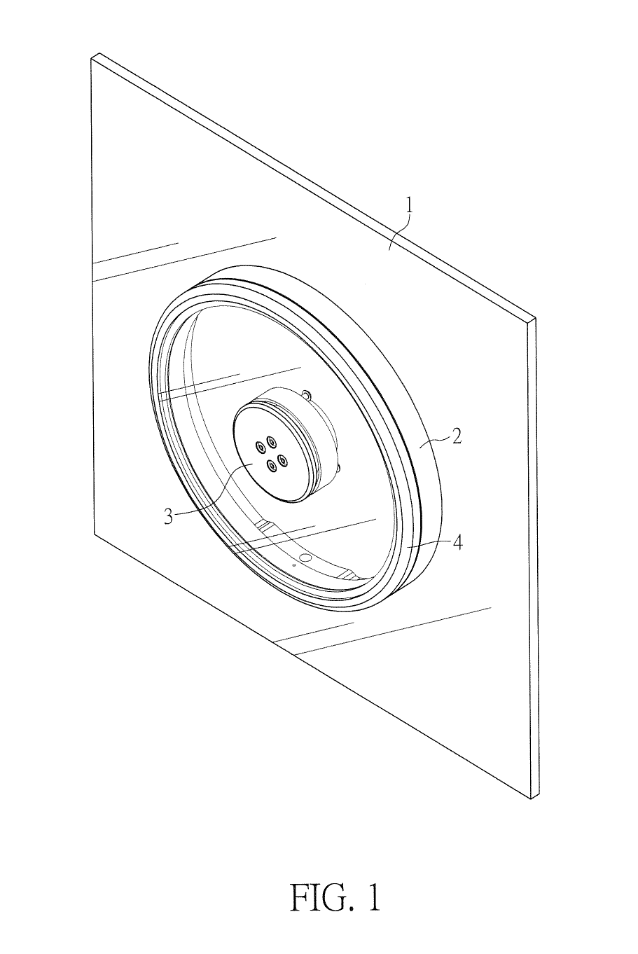

Please refer to FIG. 1 to FIG. 5, illustrating an embodiment according to the present invention. The embodiment is provided for illustrative purposes, and the claimed scope of the present invention is not limited thereto.

The embodiment provides a viewing gyro window, as shown in FIG. 1. The viewing gyro window is fixed on a transparent panel 1. In this embodiment, the transparent panel 1 is the window of a machine tool. The viewing gyro window comprises a fixed ring 2, a shaft assembly 3, and a rotating member 4.

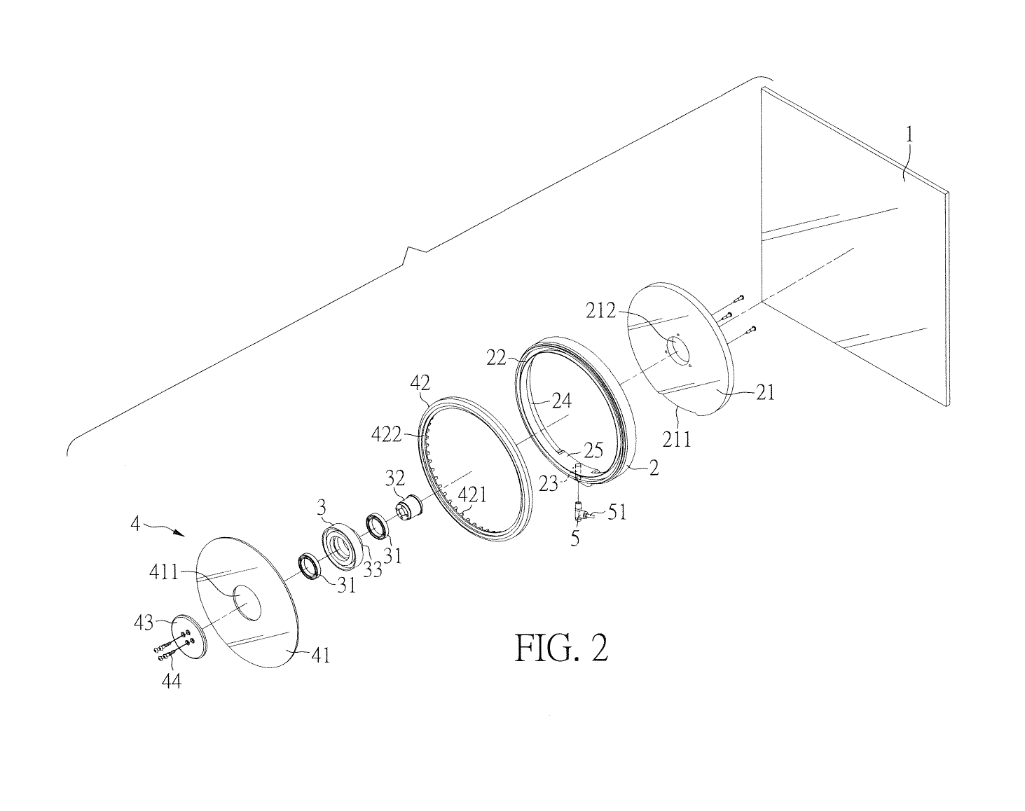

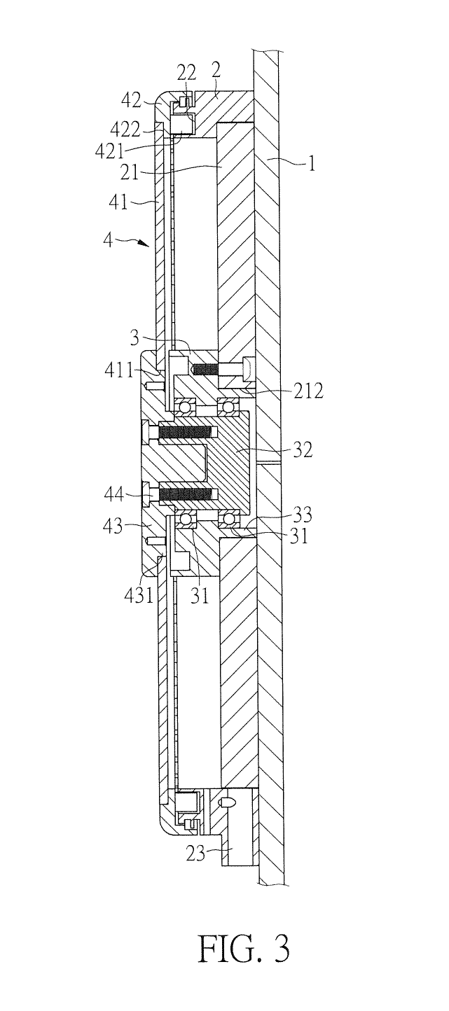

Please refer FIG. 2 to FIG. 3. The fixed ring 2 has a first side and a second side opposite to the first side. The first side of the fixed ring 2 is secured with a transparent plate 21, and the first side of the fixed ring 2 is installed on the transparent panel 1. The second side of the fixed ring 2 has an annular groove 22 defined around the periphery thereof. The fixed ring 2 has a gas inlet 23 for inputting high pressure gas. The gas inlet 23 is defined through the outer periphery of the fixed ring 2 and communicates with the annular groove 22.

Please refer FIG. 2 to FIG. 3. The first side of the fixed ring 2 has a recessed portion 24, and the recessed portion 24 corresponds to the outer diameter of the transparent plate 21. One side of the transparent plate 21 has a breach 211, and the fixed ring 2 has a stopping portion 25 protruding from the recessed portion 24 and corresponding to the breach 211 in shape. The transparent plate 21 is placed into the recessed portion 24 and positioned in the fixed ring 2, and the stopping portion 25 is correspondingly received in the breach 211. The gas inlet 23 is defined through a portion of the outer periphery of the fixed ring 2, and the stopping portion 25 is protruded from the portion.

Please refer FIG. 2 to FIG. 3. The shaft assembly 3 is assembled to the center of the transparent plate 21. The shaft assembly 3 has a bearing 31 and a rotating shaft 32, the bearing 31 is received in the shaft assembly 3, and the rotating shaft 32 is received in the shaft assembly 3 and pivoted with the bearing 31 and rotatable relative to the shaft assembly 3. In this embodiment, the center of the transparent plate 21 has an opening 212, the shaft assembly 3 has a connecting portion 33 in which the outer diameter of the connecting portion 33 corresponds to the inner diameter of the opening 212, and the connecting portion 33 of the shaft assembly 3 is received in the opening 212 so that the shaft assembly 3 is secured with the transparent plate 21.

Please refer FIG. 2 to FIG. 3. The rotating member 4 has a rotating plate 41 made of glass, and a ring 42 is fastened to the periphery of the rotating plate 41. A linkage member 43 is fastened to the center of the rotating plate 41. The linkage member 43 is secured with the rotating shaft 32 and located at the second side of the fixed ring 2, and the rotating member 4 is in no contact with the fixed ring 2. T he ring 42 has a plurality of plates 421 arranged annularly and extending toward the annular groove 22. The high pressure gas enters into the annular groove 22 to drive the plates 421 to rotate the rotating member 4.

Please refer FIG. 2 to FIG. 3. In this embodiment, the center of the rotating plate 41 has a via 411, and the linkage member 43 has a linkage part 431 in which the outer diameter of the linkage part 431 corresponds to the inner diameter of the via 411. The linkage part 431 of the linkage member 43 is received in the via 411 so that the linkage member 43 is secured with the rotating plate 41. A locking member 44 is passing through the linkage member 43 and locked with the rotating shaft 32. The ring 42 has an annular indentation 422 defined around the periphery of the rotating plate 41 and near to the rotating plate 41, and the periphery of the rotating plate 41 is received over the annular indentation 422 and the rotating plate 41 is assembled with the ring 42.

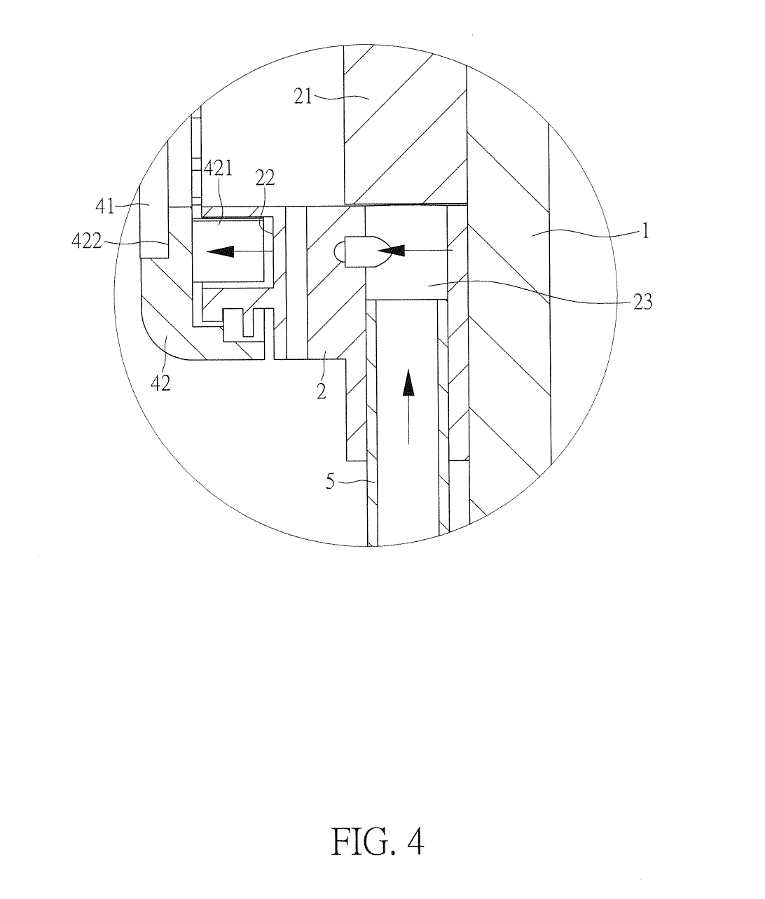

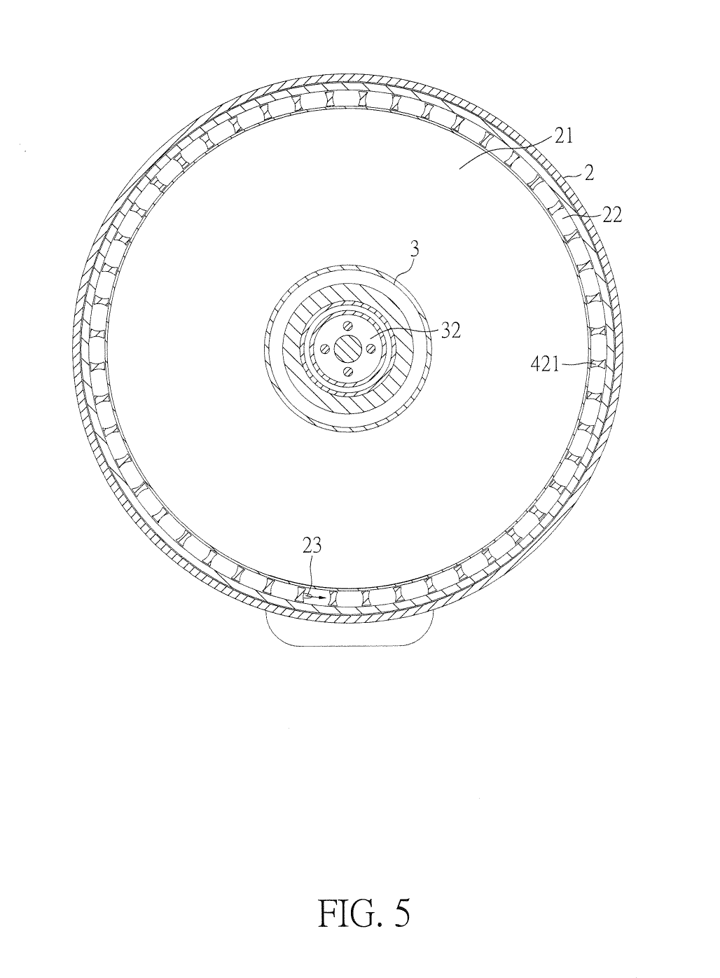

The operation of the viewing gyro window is described as following. A flow regulator 5 is affixed to the gas inlet 23 of the fixed ring 2 in which the gas inlet 23 is configured through the stopping portion 25, and the flow regulator 5 is further connected to a high pressure gas source (e.g., an air compressor) via a tube 51. When high pressure gas is delivered from the tube 51 to the gas inlet 23 via the flow regulator 5, the high pressure gas is further delivered to the annular groove 22 due to the communication between the annular groove 22 and the gas inlet 23, as shown in FIG. 4. And then, the plates 421 in the annular groove 22 would be pushed by the high pressure gas, such that the ring 42 is driven to rotate the rotating member 4, as shown in FIG. 5. Accordingly, when cut liquid for machining are spread on the transparent panel 1 during machining an article, the centrifugal force induced from the rotation of the rotating pate 41 would swing the cut liquid for machining off the transparent panel 1, so that clear visions can be provided from parts of the transparent panel 1 where the rotating plate 41 is located at. When the high pressure gas is not supplied to the gas inlet 23, the rotation of the rotating member 4 would be terminated.

The advantages of the present invention are described as following.

Firstly, the shaft assembly 3 is assembled to the center of the transparent plate 21, and the fixed ring 2 fixes the transparent plate 21 in which the outer diameter of the transparent plate 21 is mating with the inner diameter of the fixed ring 2. With the transparent feature of the transparent plate 21, the regions between the shaft assembly 3 and the fixed ring 2 are transparent and can be seen through. As compared with the conventional, the viewing gyro window enables an operator to observe the machining condition of an article in a rather beneficial way.

Secondly, if the rotating plate 41 is impacted and broken by the article unintentionally during machining, the article would be blocked by the transparent plate 21 in front of the transparent panel 1. As a result, the transparent panel 1 would not be damaged or broken easily.

Thirdly, the combination of the rotating member 4 and the rotating shaft 32 of the shaft assembly 3 is carried out by enabling the locking member 44 passing through the linkage member 43 and locked with the rotating member 4. Therefore, when the locking member 44 is detached off the linkage member 43, the linkage member 43 is then able to be detached from the rotating shaft 32, and the rotating member 4 can be detached from the viewing gyro window. As compared with the conventional, the detachment of the rotating member 4 is comparatively easy, facilitating the convenience of maintaining or repairing the rotating member 4.

Although particular embodiments of the invention have been described in detail for purposes of illustration, various modifications and enhancements may be made without departing from the spirit and scope of the invention. Accordingly, the invention is not to be limited except as by the appended claims.

1. A viewing gyro window, installed on a transparent panel, the viewing gyro window comprising:
a fixed ring, having a first side and a second side opposite to the first side, the first side being secured with a transparent plate and installed on the transparent panel, the second side having an annular groove defined around the periphery thereof, the fixed ring having a gas inlet for inputting high pressure gas, the gas inlet being defined through the outer periphery of the fixed ring and communicating with the annular groove;
a shaft assembly, assembled to the center of the transparent plate, the shaft assembly having a bearing and a rotating shaft, the bearing being received in the shaft assembly, the rotating shaft being received in the shaft assembly and pivoted with the bearing and rotatable relative to the shaft assembly;
a rotating member, having a rotating plate made of glass, a ring fastened to the periphery of the rotating plate, and a linkage member fastened to the center of the rotating plate, the linkage member secured with the rotating shaft and located at the second side of the fixed ring, the rotating member being in no contact with the fixed ring, the ring having a plurality of plates arranged annularly and extending toward the annular groove, the high pressure gas entering into the annular groove to drive the plates to rotate the rotating member.

2. The viewing gyro window according to claim 1, wherein the first side of the fixed ring has a recessed portion corresponding to the outer diameter of the transparent plate, one side of the transparent plate has a breach, the fixed ring has a stopping portion protruding from the recessed portion and corresponding to the breach in shape, the transparent plate is placed into the recessed portion and positioned in the fixed ring, and the stopping portion is correspondingly received in the breach, the gas inlet is defined through a portion of the outer periphery of the fixed ring having the stopping portion.

3. The viewing gyro window according to claim 1, wherein the center of the transparent plate has an opening, the shaft assembly has a connecting portion in which the outer diameter of the connecting portion corresponds to the inner diameter of the opening, the connecting portion of the shaft assembly is received in the opening so that the shaft assembly is secured with the transparent plate.

4. The viewing gyro window according to claim 1, wherein the center of the rotating plate of the rotating member has a via, the linkage member has a linkage part in which the outer diameter of the linkage part corresponds to the inner diameter of the via, the linkage part of the linkage member is received in the via so that the linkage member is secured with the rotating plate, a locking member is passing through the linkage member and locked with the rotating shaft, the ring has an annular indentation defined around the periphery of the rotating plate and near to the rotating plate, the periphery of the rotating plate is received over the annular indentation and the rotating plate is assembled with the ring.
